(19) United States
(12) Patent Application Publication
(10) Pub. No.: US 2018/0079389 A1
(43) Pub. Date: Mar. 22, 2018

(54) WIPER ARM CONNECTION

(71) Applicant: Robert Bosch GmbH, Stuttgart (DE)

(72) Inventor: Achim Hawighorst, Buehlertal (DE)

(21) Appl. No.: 15/562,757

(22) PCT Filed: Feb. 12, 2016
(86) PCT No.: PCT/EP2016/052970

§ 371 Date: Sep. 28, 2017

(30) Foreign Application Priority Data
Apr. 1, 2015 (DE) 10 2015 205 870.0

(51) Int. Cl. B60S 1/34

(52) U.S. Cl. CPC B60S 1/3488

(57) ABSTRACT

The invention relates to an arrangement (10) which has a wiper arm (12) provided with a wiper blade (14) for securing to an output shaft (20) of a wiper system (22), said output shaft being mounted on a paired vehicle body (16) in a pivotal manner about a central longitudinal axis (26) via at least one bearing element (24). A connection portion (30) of the wiper arm (12) can be secured to the output shaft (20) so as to be secured against rotation and in an axially movable manner in the direction of the central longitudinal axis (26) and can be spring-loaded in the direction of the vehicle body (16) by means of at least one spring element (48) which can be arranged in the region of the output shaft (20) in order to allow at least one height tolerance compensation of the wiper blade (14) of the wiper arm (12) secured to the output shaft (20) during operation.

### BACKGROUND OF THE INVENTION

The present invention relates to an arrangement which has a wiper arm provided with a wiper blade for securing to an output shaft of a wiper system, said output shaft being mounted on an associated vehicle body in a rotatably movable manner about a central longitudinal axis via at least one bearing element.

A wiper system comprising a wiper arm and a wiper joint is known from the prior art, in which the wiper joint is positioned between a wiper arm receiver and a wiper blade retaining arm. By means of the wiper arm receiver, the wiper arm is mounted on a conical and longitudinally knurled end portion of an output shaft of the wiper system, for example, and secured there by means of a connection nut. A bearing force of the wiper blade which is generally required for correct wiper operation on an associated vehicle windshield is produced in this case, for example, by means of a tension spring which is arranged between the wiper blade retaining arm with the wiper blade secured thereto and the wiper arm receiver.

### SUMMARY OF THE INVENTION

According to the present invention, an arrangement which has a wiper arm provided with a wiper blade for securing to an output shaft of a wiper system is provided, said output shaft being mounted on an associated vehicle body in a rotatably movable manner about a central longitudinal axis via at least one bearing element, wherein a connection portion of the wiper arm can be secured to the output shaft so as to be secured against rotation and in an axially movable manner in the direction of the central longitudinal axis and can be spring-loaded in the direction of the vehicle body by means of at least one spring element which can be arranged in the region of the output shaft in order to allow at least one height tolerance compensation of the wiper blade of the wiper arm secured to the output shaft during operation.

The invention thus permits the formation of a height-adjustable and joint-free wiper arm connection for securing a wiper arm to an output shaft of a wiper system for a motor vehicle. This wiper arm connection permits an at least substantial compensation of tolerances which are produced, amongst other things, by a deviation in the position of the output shaft from an ideal spatial position provided structurally in each case. Such a deviation in the position may have many different causes, such as for example tolerances of the output shaft itself, assembly tolerances or even production tolerances of the vehicle body. In this case, at least one efficient height tolerance compensation of the wiper blade is permitted during operation so that advantageously a joint-free wiper arm may be used, said joint-free wiper arm also being able to apply the wiper blade with a predetermined bearing force against a vehicle windshield to be cleaned by means of the wiper blade, as a result of the spring element.

According to one embodiment, a connection element is able to be secured in an axially immovable manner to an end portion of the output shaft and the connection portion of the wiper arm comprises a receiver for the at least partially positive receiving of the connection element.

As a result, the height tolerance compensation may be permitted in a simple manner, in addition to a production of a required contact force for the wiper arm. The positive connection may be designed, for example, with an axial toothing of an outer surface of the connection element and a correspondingly designed axial toothing of an inner surface of the receiver. Alternatively, the outer and inner surfaces may also have corresponding polygonal cross-sectional geometries. In principle, however, any geometric pairings which permit a rotationally fixed but axially displaceable coupling between the connection element and the receiver in the connection portion of the wiper arm may be used. By a conical design of the end portion of the output shaft, for example, and a correspondingly configured opening in the connection element, a particularly stable and at the same time wobble-free securing of the connection element on the output shaft is provided.

Preferably, the at least one spring element is able to be supported between the connection element and a base of the receiver, wherein the base of the receiver comprises an opening for passing through the output shaft.

As a result, the connection portion and thus the wiper blade are always pressed with a predetermined bearing force against the vehicle windshield. The spring element may be formed by an elastomer, by a foamed plastics material, by a cylindrical spiral compression spring configured as a compression spring, etc.

Preferably, the connection element comprises an opening for arranging on the end portion of the output shaft and is able to be fixed in position thereon by means of an associated securing element.

As a result, a structurally simple securing of the position of the connection element on the end portion of the output shaft is provided. The end portion of the output shaft in this case is preferably configured conically and preferably provided with knurling for producing a combined positive and press-fit connection with the opening in the connection element. For example, a screw nut or a so-called Speednut® may be used as a securing element.

Preferably, the receiver is able to be closed by an associated closure element.

As a result, the penetration of foreign particles in the receiver after mounting the wiper arm on the output shaft is efficiently avoided, so that a smooth-running displaceability of the wiper arm on the output shaft is ensured over the long term.

According to a further embodiment, the connection portion of the wiper arm comprises a receiver with a base and an opening for the at least partially positive receiving of a coupling portion of the output shaft is incorporated in the base.

As a result, a displaceability of the connection portion of the wiper arm on the output shaft, which is fixed in terms of rotation and at the same time axially limited, is provided. Consequently, the use of a separate coupling element may be dispensed with.

Preferably, an insertion element is provided in the opening, said insertion element being able to be positioned in the region between the coupling portion of the output shaft and the opening.

The insertion element results, amongst other things, in an improved torque transmission between the output shaft and the connection portion of the wiper arm secured thereto. In the case of wear, the insertion element may also be easily replaced.

Preferably, the insertion element is at least partially configured in the manner of a hollow-cylindrical sleeve which is configured to enclose at least partially coaxially the coupling portion of the output shaft, wherein a radially outwardly oriented flange is formed on an axial sleeve end.

Due to the increased diameter of the flange in comparison with an output shaft diameter, the capacity for torque transmission of the connection between the output shaft and the connection portion of the wiper arm is improved. The sleeve may, for example, be partially encapsulated by injection-molding with the material of the wiper arm.

Preferably, at least one spring element is provided, said spring element being able to be arranged between a securing element provided on an end portion of the output shaft and the base of the receiver and/or the flange of the insertion element.

As a result, a reliable securing of the connection portion of the wiper arm on the output shaft is provided.

Preferably, the receiver is able to be closed by a closure element. As a result, the penetration of foreign particles and moisture is avoided, so that the ease of movement of the axial displaceability is ensured over the long term.

### BRIEF DESCRIPTION OF THE DRAWINGS

The invention is described in more detail in the following description, with reference to exemplary embodiments shown in the drawings, in which:

FIG. 1 shows a schematic longitudinal section through an arrangement for securing a wiper arm with a wiper blade to an output shaft of a wiper system according to a first embodiment,

FIG. 2 shows a plan view of the arrangement of FIG. 1,

FIG. 3 shows a schematic longitudinal section through a second and third embodiment of an arrangement for securing a wiper arm with a wiper blade to an output shaft of a wiper system,

FIG. 4 shows a fourth embodiment of an arrangement for securing a wiper arm with a wiper blade to an output shaft of a wiper system, and

FIG. 5 shows a fifth embodiment of an arrangement for securing a wiper arm with a wiper blade to an output shaft of a wiper system.

### DETAILED DESCRIPTION

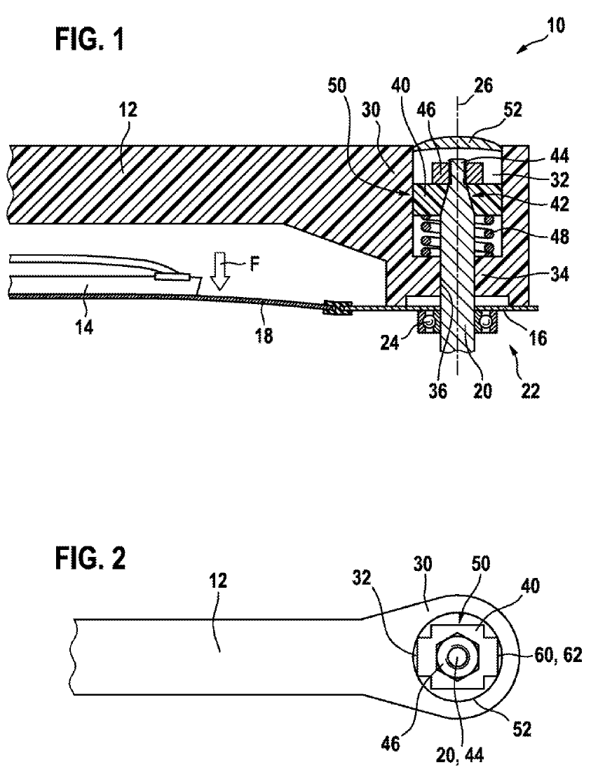

FIG. 1 shows an arrangement 10 configured according to a first embodiment with a wiper arm 12 and a wiper blade 14 secured thereto on the lower face, for cleaning a vehicle windshield 18 inserted in a vehicle body 16. The wiper arm 12 is preferably formed by an optionally fiber-reinforced thermoplastics material. Moreover, by way of illustration, the arrangement 10 has an output shaft 20 as part of a wiper system 22, said output shaft being mounted by means of a bearing element 24 in a rotatably movable manner about a central longitudinal axis 26 in the vehicle body 16. The output shaft 20 is preferably formed by a metal material.

A receiver 32 is preferably incorporated in a connection portion 30 of the wiper arm 12, the base 34 of said receiver preferably having an opening 36 for passing through the output shaft 20. A connection element 40 is at least partially positively received in the receiver 32. This connection element 40 has an opening 42 for passing through an end portion 44 of the output shaft 20 which in this case by way of example is at least partially conically configured. By means of a securing element 46 designed by way of example here as a self-locking screw nut, as a Speednut® or the like, the connection element 40 is secured to the end portion 44 of the output shaft 20.

Preferably, a spring element 48 is tensioned between the connection element 40 and the base 34 of the receiver 32, said spring element in this case by way of example being designed as a cylindrical spiral compression spring. Instead of a cylindrical spiral compression spring a further resilient element, such as for example a spring element made of an elastomer or the like, may be provided.

Due to the action of the force of this spring element 48, the wiper arm 12 and thus also the wiper blade 14 are pressed and/or brought to bear with a defined force F against the motor vehicle windshield 18, wherein the connection element 40 serves as an abutment. An exposed tension spring for ensuring sufficient contact force of the wiper arm 12 is thus superfluous. As a result of the axial displaceability of the wiper arm 12 in relation to the vehicle windshield and/or vehicle body 16, 18, at the same time a comprehensive compensation of tolerance deviations is possible, said tolerance deviations occurring, for example, due to mounting tolerances, dimensional deviations of the vehicle body or production tolerances of the wiper system 22 itself.

A positive connection 50 preferably exists between the connection element 40 and the recess 32. By this positive connection 50, on the one hand, the connection portion 30 of the wiper arm 12 is connected fixedly in terms of rotation to the connection element 40 and thus to the output shaft 20 and, on the other hand, at the same time the connection portion is axially displaced counter to the action of force of the spring element 48 and/or parallel to the central longitudinal axis 26 on the connection element 40. The axial movement path in this case is restricted by the wiper blade 14 and the fully compressed spring element 48.

By means of a cap-shaped closure element 52 the receiver 32 is preferably protected against damaging environmental influences, in particular against the penetration of foreign particles, etc. Moreover, the overall visual impression of the arrangement 10 is improved by the closure element 52.

FIG. 2 shows the connection element 40 of FIG. 1 which by means of the securing element 46 of FIG. 1 is secured fixedly in terms of rotation and axially immovably to the end portion 44 of the output shaft 20 of FIG. 1. For producing the above-described positive connection 50 of FIG. 1 the connection element 40 has in this case, merely by way of example, a polygonal peripheral cross-sectional geometry 60 which engages in a correspondingly configured polygonal cross-sectional geometry 62 on the inner face of the receiver 32 of FIG. 1.

Alternatively, the positive connection 50 may be designed, for example, with an axial toothing of an outer surface of the connection element 40 and a correspondingly designed axial toothing of an inner surface of the receiver 32. In principle, however, any geometric pairing may be used which permits a coupling between the connection element 40 and the receiver 32 in the connection portion 30 of the wiper arm 12 of FIG. 1 which is fixed in terms of rotation but at the same time axially displaceable.

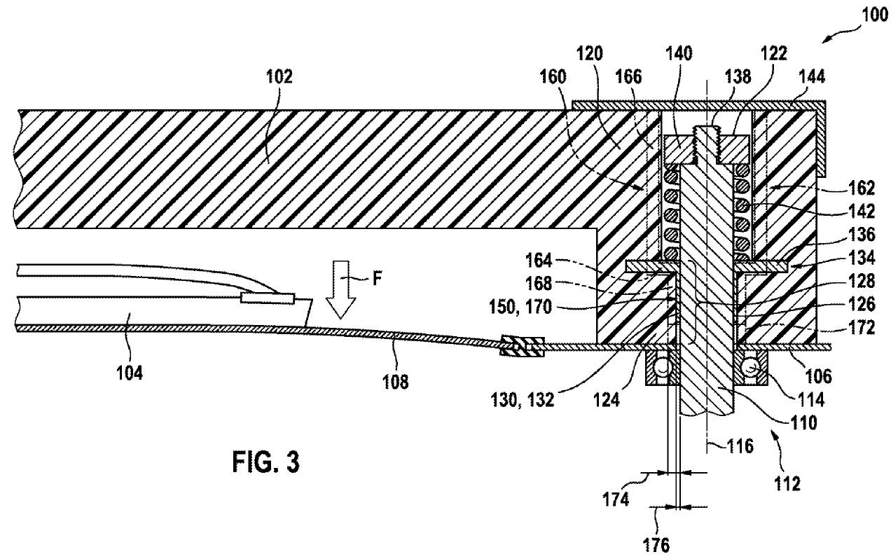

FIG. 3 shows an arrangement 100 configured according to a second and third embodiment which preferably has a wiper arm 102 with a wiper blade 104 secured thereto on a lower face for cleaning a vehicle windshield 108 inserted into a vehicle body 106. Moreover, the arrangement 100 preferably has an output shaft 110 as part of a wiper system 112, said output shaft being mounted by means of a bearing element 114 in a rotatably movable manner about a central longitudinal axis 116 in the vehicle body 106.

Preferably a receiver 122 is incorporated in a connection portion 120 of the wiper arm 102, the base 124 of said receiver preferably having a continuous opening 126 for passing through a coupling portion 128 of the output shaft 110. An insertion element 130 is arranged in the opening 126, said insertion element in this case being designed, merely by way of example, in the manner of a hollow-cylindrical sleeve 132 with a circular flange 136 which is arranged on a sleeve end 134 facing away from the vehicle body 106 and which is oriented radially outwardly.

A securing element 140 is preferably arranged on an end portion 138 of the output shaft 110, said securing element being, for example, a self-locking screw nut, a Speednut® or the like. Preferably a spring element 142 is tensioned between the securing element 140 and the flange 136 and/or the base 124 of the receiver 122, said spring element once again by way of illustration being designed as a cylindrical spiral compression spring and being supported between the securing element 140 serving as an abutment and the flange 136 of the sleeve 132. Instead of a cylindrical spiral compression spring, a further resilient element, such as for example a spring element made of an elastomer or the like, may be provided.

The sleeve 132 is preferably non-positively connected to the connection portion 120 of the wiper arm 102. This may be implemented, for example, by the sleeve 132 being externally encapsulated by injection-molding and the flange 136 being at least partially encapsulated by injection-molding with the material of the wiper arm 102, which preferably is optionally a fiber-reinforced thermoplastics material. The sleeve 132, however, may be formed by a metal material or by a plastics material.

Due to the action of the force of the spring element 142 the wiper blade 104 secured to the wiper arm 102, as in the first embodiment, is pressed by the force F against the vehicle windshield 108. A suitable positive connection 150 preferably exists between the coupling portion 128 of the output shaft 110 and the sleeve 132. By this positive connection 150 the wiper arm 102 is connected fixedly in terms of rotation to the output shaft 110 and at the same time is able to be axially displaced thereon and/or parallel to the central longitudinal axis 116, so that a tolerance compensation and a height compensation is possible between the vehicle windshield 108 and the wiper blade 104 guided on the wiper arm 102. The positive connection 150 may be implemented, for example, by a longitudinal toothing of the coupling portion 128 and a correspondingly configured inner toothing of an inner surface of the sleeve 132, not denoted. The receiver 122 in the connection portion 120 is not sealed by a cap-shaped closure element but instead by a closure element 144 with an L-shaped cross-sectional geometry, for protecting against foreign bodies and for improving the overall visual impression.

In the case of a third embodiment—as indicated by dashed lines—instead of the insertion element 130, an insertion element 160 may be provided which, in contrast to the hollow-cylindrical sleeve 132 with the radial flange 136 on the end side, is preferably formed by a substantially hollow-cylindrical sleeve 162 with a peripheral shoulder 164, wherein in each case a hollow-cylindrical portion 166, 168 is adjoined to each side of the shoulder 164. The securing of the insertion element 160 in the receiver 122 may take place, for example, by external encapsulation by injection-molding with the material of the wiper arm 102. Alternatively, the insertion element 160 may also be press-fitted into the receiver 122 or bonded or welded thereto.

Between the portion 168—which in comparison with the portion 166 has a reduced diameter—and the coupling portion 128 of the output shaft 110, preferably also exists a suitable positive connection 170 which, on the one hand, permits a connection of the connection portion 120 of the wiper arm 102 to the output shaft 110 which is fixed in terms of rotation and, on the other hand, the axial displaceability thereof for tolerance compensation thereon. An opening 172 has—as indicated by two dashed lines—an increased diameter for the preferably free, unhindered through-passage of the output shaft 110 outside its coupling portion 128, in comparison with the opening 126 of the third embodiment. Moreover, a material thickness 174 and/or a wall thickness of the hollow-cylindrical portions 166, 168 of the insertion element 160, in comparison with a material thickness 176 of the sleeve 132, is preferably increased in the region of the coupling portion 128 of the output shaft 110. In the case where the wiper arm 102 and/or the connection portion 120 thereof is formed by a metal material, optionally both the insertion element 130 and the insertion element 160 may be dispensed with.

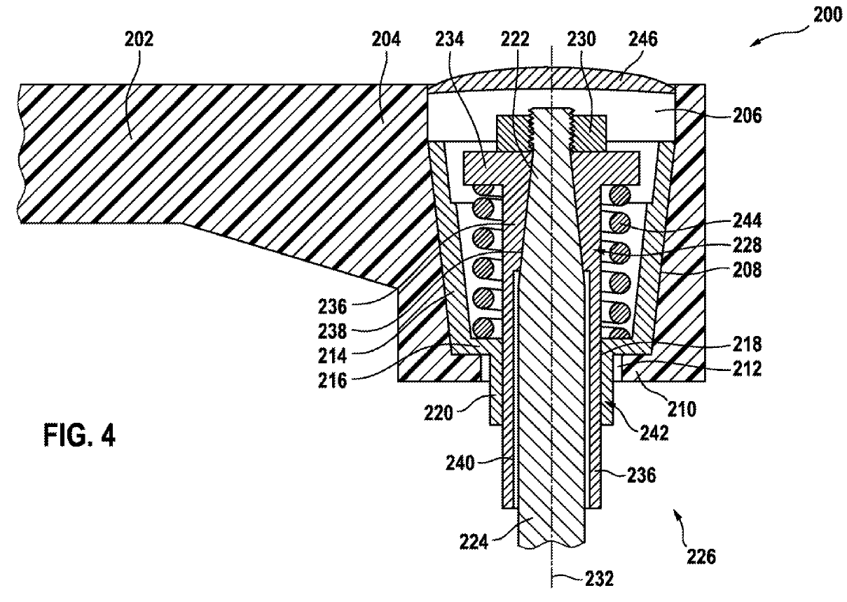

FIG. 4 shows an arrangement 200 configured according to a fourth embodiment with a wiper arm 202 of a wiper system 226 which comprises a receiver portion 204, preferably with an at least approximately pot-shaped receiver 206, which in this case is provided merely by way of example with a partially slightly conically extending inner surface 208. The receiver 206 has by way of illustration a base 210 with an opening 212. An approximately pot-shaped insertion element 214 is preferably arranged in the receiver 206, the also preferably slightly conical geometry thereof being designed so as to correspond to the shape of the receiver 206.

A base 216 of the insertion element 214 has an opening 218 which runs axially into a hollow-cylindrical and/or sleeve-like extension 220, by way of illustration. This extension 220 passes through the opening 212 in the base 210 of the receiver 206 in the connection portion 204 of the wiper arm 202. Between the extension 220 and the opening 218 optionally an annular gap, not denoted for improved clarity of the drawings, may be provided.

The insertion element 214 in this fourth embodiment is preferably secured by means of a positive connection in the receiver 206 for optimizing production and may, for example, be secured in the axial position illustrated here by means of an at least partially peripheral stop, not shown, for example on the circumference. Alternatively, the insertion element 214 may also be secured by encapsulation by injection-molding with the material of the wiper arm 202 by press-fitting, bonding or by welding inside the receiver 206.

On a preferably conical end portion 222 of an output shaft 224 of the wiper system 226, a preferably substantially sleeve-like and/or hollow cylindrical connection element 228 is secured by means of a securing element 230 fixedly in terms of rotation and axially immovably and/or undisplaceably along a central longitudinal axis 232. The connection element 228 has by way of illustration a circular, radially outwardly oriented flange 234, a hollow shaft 236 adjoining thereon on the lower face. A conical opening 238 for the at least partially positive receiving of the end portion 222 of the output shaft 224 preferably extends in the region of the flange 234. The conical opening 238 runs via a shoulder, not denoted for improved clarity, into an opening 240 which passes entirely through the remaining shaft 236 in order to pass through the output shaft 224. The extension 220 of the insertion element 214 coaxially encloses the shaft 236 of the connection element 228, preferably without clearance, wherein preferably a positive connection 242 at least partially exists between these components, which in turn provides the desired connection which is fixed in terms of rotation, but is an axially displaceable connection. A width of the opening 240 may optionally be dimensioned such that a narrow annular gap, not denoted, exists between the output shaft 224 and the shaft 236.

Preferably once again a spring element 244 is tensioned between the flange 234 and the base 216 of the insertion element 214, said spring element being designed here by way of example as a cylindrical spiral compression spring. The action of force of the spring element 244 permits the axial-resilient tolerance compensation and the contact of the wiper blade secured to the wiper arm 202, but not illustrated here, against a vehicle windshield with a defined force. The shaft 236 of the connection element 228 protrudes, at least in the tensioned state of the spring element 244 shown here, beyond the extension 220 of the insertion element 214.

Since the insertion element 214 and the connection element 228 in each case are designed as a separate shaped component, in this fourth embodiment there is the advantage of a secure and permanently accessible axial mobility of the wiper arm 202 in relation to the output shaft 224. A length of the insertion element 214 and the connection element 228 may vary. If required, the positive connection 242 formed between the extension 220 of the insertion element 214 and the shaft 236 of the connection element 228 which provides an axial sliding surface, not denoted for the sake of improved clarity of the drawings, may be at least partially provided with an elastomer.

Different materials may also be used for the insertion element 214 and the connection element 228 for a further reduction of friction. The receiver 206 in the connection portion 204 of the wiper arm 202 is also closed by a closure element 246.

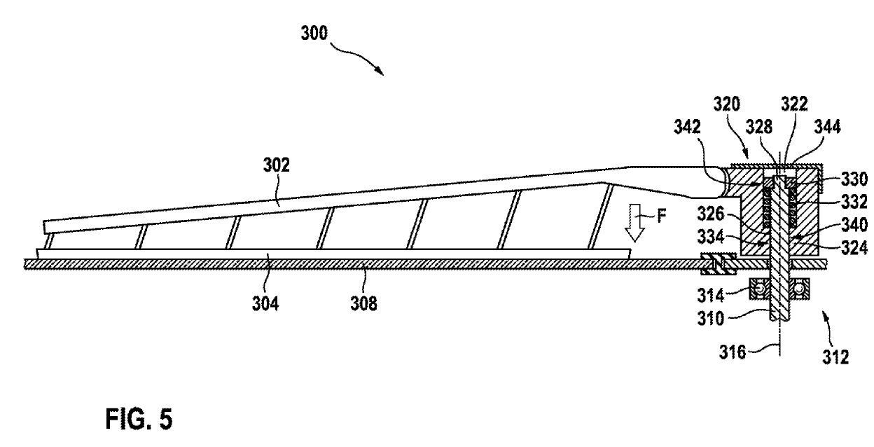

FIG. 5 shows an arrangement 300 configured according to a fifth embodiment which preferably has a wiper arm 302 with a wiper blade 304 secured thereto on the lower face, for cleaning a vehicle windshield 308. The arrangement 300 also preferably has an output shaft 310 as part of a wiper system 312 which is mounted by means of a bearing element 314 in a rotatably movable manner about a central longitudinal axis 316. The wiper blade 304 in this case by way of example is designed as a so-called fin-ray wiper blade.

Preferably a receiver 322 is incorporated in a connection portion 320 of the wiper arm 302, the base 324 of said receiver having a correspondingly dimensioned opening 326 for passing through the at least partially cylindrical output shaft 310. Preferably a securing element 330 is secured to an end portion 328 of the output shaft 310, said securing element being able to be designed, for example, as a self-locking screw nut, as a Speednut® or the like. Optionally, the securing element 330 may have a washer designed separately or integrally.

Preferably a spring element 332 is tensioned between the securing element 330 and the base 324, said spring element being designed here by way of example as a cylindrical spiral compression spring. Due to the action of the force of this spring element 332, the wiper arm 302 and thus the wiper blade 304 are pressed with a defined force F against the vehicle windshield 308 and/or brought to bear thereagainst, wherein the securing element 330 serves as an abutment. Between a coupling portion 334 of the output shaft 310 and the opening 326 in the base 324 of the receiver 322 preferably exists a suitable positive connection 340 which provides a mechanical connection which is fixed in terms of rotation but at the same time is displaceable parallel to the central longitudinal axis 316 between the connection portion 320 and the output shaft 310. Alternatively or additionally, a further positive connection 342 may optionally be provided between the periphery of the securing element 330 itself and an inner surface of the receiver 322, not denoted.

As a result of such axial displaceability of the wiper arm 302 provided in relation to the vehicle windshield 308, once again it is possible to implement different types of compensation of tolerance deviations which occur, for example, due to mounting tolerances, dimensional deviations of the vehicle body or production tolerances of the wiper system 312 itself. The receiver 322 is once again covered by an angled closure element 344.

At least the connection portion 320 of the wiper arm 302 is formed by a metal material—as is also the output shaft 310. In contrast to the above embodiments in the arrangement 300, neither a connection element nor an insertion element is provided. If required a joint, in particular a film hinge or the like, may be provided between the connection portion 320 and the wiper arm 302.

1. An arrangement (10, 100) which has a wiper arm (12, 102) provided with a wiper blade (14, 104) for securing to an output shaft (20, 110) of a wiper system (22, 112), said output shaft being mounted on an associated vehicle body (16, 106) in a rotatably movable manner about a central longitudinal axis (26, 116) via at least one bearing element (24, 114), characterized in that a connection portion (30, 120) of the wiper arm (12, 102) is configured to be secured to the output shaft (20, 110) so as to be secured against rotation and in an axially movable manner in the direction of the central longitudinal axis (26, 116) and is configured to be spring-loaded in the direction of the vehicle body (16, 106) by means of at least one spring element (48, 142) which is configured to be arranged in the region of the output shaft (20, 110) in order to allow at least one height tolerance compensation of the wiper blade (14, 104) of the wiper arm (12, 102) secured to the output shaft (20, 110) during operation.

2. The arrangement as claimed in claim 1, characterized in that a connection element (40) is configured to be secured in an axially immovable manner to an end portion (44) of the output shaft (20) and the connection portion (30) of the wiper arm (12) comprises a receiver (32) for the at least partially positive receiving of the connection element (40).

3. The arrangement as claimed in claim 2, characterized in that the at least one spring element (48) is configured to be supported between the connection element (40) and a base (34) of the receiver (32), wherein the base (34) of the receiver (32) comprises an opening (36) for passing through the output shaft (20).

4. The arrangement as claimed in claim 2, characterized in that the connection element (40) comprises an opening (42) for arranging on the end portion (44) of the output shaft (20) and is configured to be fixed in position thereon by means of an associated securing element (46).

5. The arrangement as claimed in claim 2, characterized in that the receiver (32) is configured to be closed by an associated closure element (52).

6. The arrangement as claimed in claim 1, characterized in that the connection portion (120) of the wiper arm (102) comprises a receiver (122) with a base (124) and an opening (126) for the at least partially positive receiving of a coupling portion (128) of the output shaft (110) is incorporated in the base (124).

7. The arrangement as claimed in claim 6, characterized in that an insertion element (130) is provided in the opening (126), said insertion element being configured to be positioned in the region between the coupling portion (128) of the output shaft (110) and the opening (126).

8. The arrangement as claimed in claim 7, characterized in that the insertion element (130) is at least partially configured in the manner of a hollow-cylindrical sleeve (132) which is configured to enclose at least partially coaxially the coupling portion (128) of the output shaft (110), wherein a radially outwardly oriented flange (136) is formed on an axial sleeve end (134).

9. The arrangement as claimed in claim 6, characterized in that at least one spring element (142) is provided, said spring element being configured to be arranged between a securing element (140) provided on an end portion (138) of the output shaft (110) and the base (124) of the receiver (122) and/or the flange (136) of the insertion element (130).

10. The arrangement as claimed in claim 6, characterized in that the receiver (122) is configured to be closed by a closure element (144).

11. A wiper blade arrangement (10, 100) comprising an output shaft configured to be mounted on an associated vehicle body (16, 106) in a rotatably movable manner about a central longitudinal axis (26, 116) via at least one bearing element (24, 114), a wiper arm (12, 102) provided with a wiper blade (14, 104), the wiper arm being secured to the output shaft (20, 110), wherein a connection portion (30, 120) of the wiper arm (12, 102) is secured to the output shaft (20, 110) so as to be secured against rotation and in an axially movable manner in the direction of the central longitudinal axis (26, 116) and is spring-loaded in the direction of the vehicle body (16, 106) by at least one spring element (48, 142) which is arranged in the region of the output shaft (20, 110) in order to allow at least one height tolerance compensation of the wiper blade (14, 104) of the wiper arm (12, 102) secured to the output shaft (20, 110) during operation.

12. The wiper blade arrangement as claimed in claim 11, characterized in that a connection element (40) is secured in an axially immovable manner to an end portion (44) of the output shaft (20) and the connection portion (30) of the wiper arm (12) comprises a receiver (32) for the at least partially positive receiving of the connection element (40).

13. The wiper blade arrangement as claimed in claim 12, characterized in that the at least one spring element (48) is supported between the connection element (40) and a base (34) of the receiver (32), wherein the base (34) of the receiver (32) comprises an opening (36) for passing through the output shaft (20).

14. The wiper blade arrangement as claimed in claim 12, characterized in that the connection element (40) comprises an opening (42) for arranging on the end portion (44) of the output shaft (20) and is fixed in position thereon by means of an associated securing element (46).

15. The wiper blade arrangement as claimed in claim 12, characterized in that the receiver (32) is closed by an associated closure element (52).

16. The wiper blade arrangement as claimed in claim 11, characterized in that the connection portion (120) of the wiper arm (102) comprises a receiver (122) with a base (124) and an opening (126) for the at least partially positive receiving of a coupling portion (128) of the output shaft (110) is incorporated in the base (124).

17. The wiper blade arrangement as claimed in claim 16, characterized in that an insertion element (130) is provided in the opening (126), said insertion element being positioned in the region between the coupling portion (128) of the output shaft (110) and the opening (126).

18. The wiper blade arrangement as claimed in claim 17, characterized in that the insertion element (130) is at least partially configured in the manner of a hollow-cylindrical sleeve (132) which encloses at least partially coaxially the coupling portion (128) of the output shaft (110), wherein a radially outwardly oriented flange (136) is formed on an axial sleeve end (134).

19. The wiper blade arrangement as claimed in claim 16, characterized in that at least one spring element (142) is provided, said spring element being arranged between a securing element (140) provided on an end portion (138) of the output shaft (110) and the base (124) of the receiver (122) and/or the flange (136) of the insertion element (130).

20. The wiper blade arrangement as claimed in claim 16, characterized in that the receiver (122) is closed by a closure element (144).
